(19) United States
(12) Patent Application Publication
(10) Pub. No.: US 2020/0321761 A1
(43) Pub. Date: Oct. 8, 2020

(54) Improved gasket for the fastening of cables, tubes and other elongated bodies in general having different diameters

(71) Applicant: Fi.Mo.Tec. S.p.A., Milano (IT)

(72) Inventor: Alberto Varale, Cologno Monzese (MI) (IT)

(21) Appl. No.: 16/300,954

(22) PCT Filed: May 10, 2017
(86) PCT No.: PCT/EP2017/061128

§ 371 Date: Nov. 13, 2018

(30) Foreign Application Priority Data
May 19, 2016 (IT) 102016000051397

(51) Int. Cl. H02G 3/32; F16L 3/13; H01R 13/52

(52) U.S. Cl. CPC H02G 3/32; H01R 13/5205; F16L 3/13

(57) ABSTRACT

A gasket for fastening cables, tubes and other elongated bodies having different diameters includes two half-shells joined together by a hinge at their contiguous edges, and diaphragms inside the half-shells. Elastic arms, provided protruding inside the gasket, are fastened to the inner surface of the half-shells. The gasket withholds a cable against axial slipping, increasing contact surface of the gasket on cables having a larger diameter, and pressure exerted on the cable, proportioning it to the dimensions and weight of the cable. This provides for a more reliable and safer anchoring of the cable.

The present invention relates to an improved gasket for the fastening of cables, tubes and other elongated bodies in general, having different diameters.

The field of the invention relates to devices used for fastening elongated bodies in general such as cables, tubes and the like on a support, for example pylons used for supporting telecommunication antennas.

In this field, it is important that the supporting device exert an effective supporting action on the cable, preventing it from slipping or moving out of its initial seat, due to its own weight or the action of atmospheric agents.

In this type of application there is also the necessity of making the fastening device as universal as possible with respect to the different construction diameters of cables, from the smallest, such as, for example, optical fiber cables, to those having a larger diameter, such as coaxial cables. For this purpose, the production is known of devices provided with elastic gaskets having a substantially tubular form, having internal diaphragms, suitable for being deformed so as to make the gasket compatible with the fastening of cables having different dimensions.

In the devices of the type described, the diaphragm simultaneously exerts the double function of becoming deformed according to the diameter of the cable and withholding it on the gasket against axial slipping.

The known gaskets, however, have the disadvantage that the deformation imposed on the gasket by the tube having a larger diameter increases the contact surface between the diaphragm and the cable, but leaves the compression exerted by the diaphragm on the cable itself, unaltered. A known gasket is consequently unable to generate on the cable having a larger diameter, and therefore having a greater weight, a compression proportional to the increase in the diameter of the cable, as the withholding action of the latter is generated exclusively by the increase in the contact surface of the outer surface of the cable with the diaphragm.

The main objective of the present invention is to provide an improved gasket, which is capable of exerting an effective axial retaining action also on cables having different dimensions, contributing to said retaining or withholding action not only due to the increase in the contact surface of the gasket with the cable, but also as a result of an additional compression action which the gasket generates on the cable itself.

These and other objectives are achieved with the gasket of claim 1. Preferred embodiments of the invention are specified in the remaining claims.

With respect to the known gaskets for cables having a differentiated diameter, that according to the invention offers the advantage of withholding the cable against axial slipping, intervening not only on the increase in the contact surface of the gasket on cables having a larger diameter, but also on the pressure exerted by the same on the cable, proportioning it to the dimensions and therefore weight of the latter. In this way, a more reliable and safer anchoring degree of the cable is obtained with respect to analogous devices of the known art which, as they are not provided with means capable of exerting this double withholding function, do not even allow the results offered by the gasket of the invention, to be obtained.

These and other objectives, advantages and characteristics appear evident from the following description of a preferred embodiment for producing the gasket of the invention illustrated, for non-limiting purposes, in the figures of the enclosed drawings.

In these:

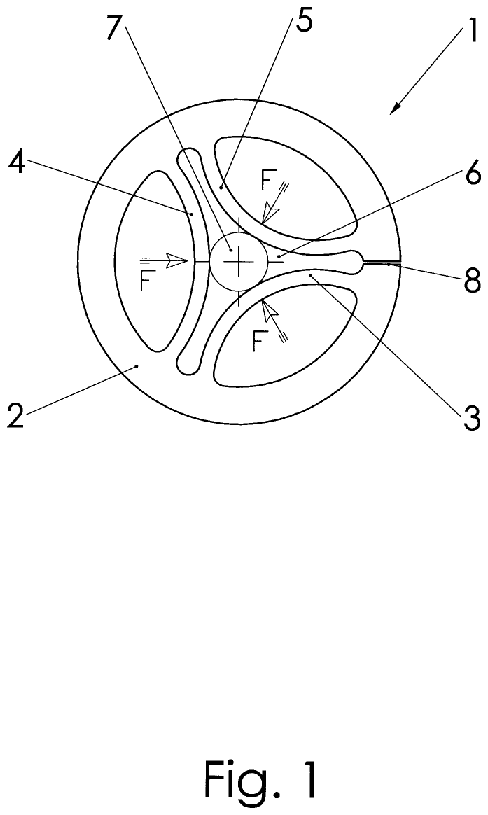

FIG. 1 illustrates in a transversal section, a gasket of the known art;

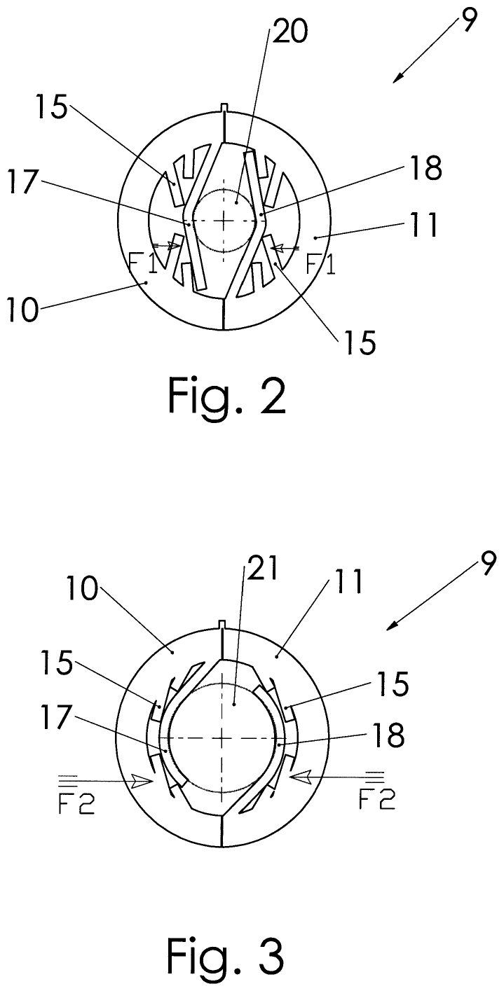

FIGS. 2 and 3 illustrate the gasket of the invention, with a cable having a small and large diameter respectively, installed in its interior;

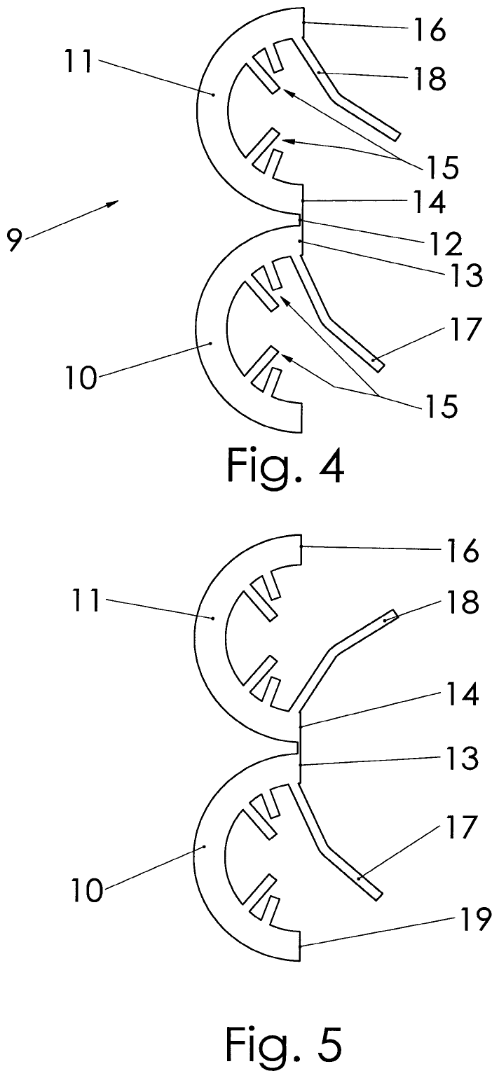

FIG. 4 illustrates the gasket of FIGS. 2 and 3 in an open state;

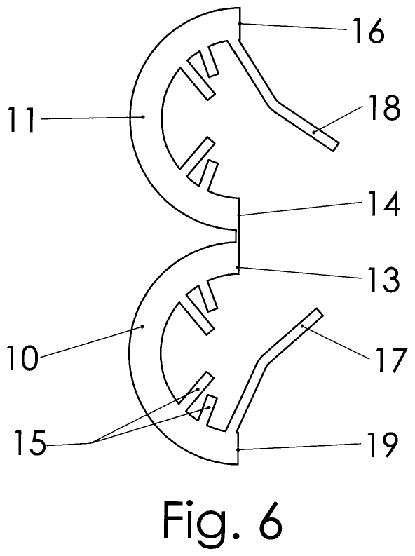

FIGS. 5 and 6 illustrate variants of the gasket of FIG. 4; and

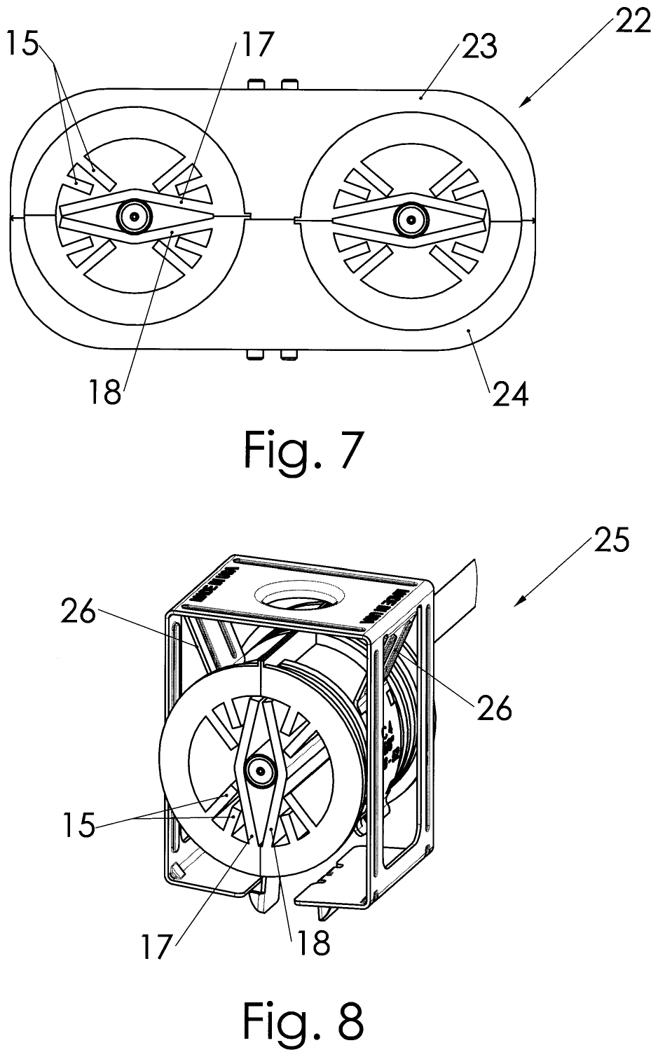

FIGS. 7 and 8 illustrate the gasket of the invention according to FIGS. 5 and 6, respectively, as assembled within respective cable-clamping systems.

The gasket 1 of FIG. 1 is composed of a substantially tubular body 2, made of elastomeric material. Protruding diaphragms 3, 4 and 5 are also provided inside the body 2, which define, in correspondence with the innermost area of the tubular body 2, the housing seat 6 of the cable 7. The latter is then introduced into the same seat 6 of the gasket 1 for passing through an opening 8 formed in the thickness of said body 2.

In this type of known solution, the retention stress of the cable 7 against axial slipping is exclusively ensured by the increase in the contact surface between the cable 7 and the diaphragms 3, 4 and 5, generated by the introduction of cables 7 having a larger diameter into the above-mentioned seat 6. For this reason, the stress exerted by the above-mentioned diaphragms on the outer surface of the cable 7, in the direction of the arrows F of FIG. 1, remains substantially unchanged with an increase in the diameter, and therefore weight of the cable. Known gaskets are consequently unable to adapt the compression on the cable 7, and therefore the stress necessary for withholding it, with an increase in the diameter of the cable itself.

In order to overcome the above drawbacks, the gasket of the invention, indicated as a whole with 9 in FIG. 4, comprises two half-shells 10 and 11 made of elastomeric material and having a substantially arch-shaped section. The same half-shells 10 and 11 are also reciprocally joined by means of a hinge 12, also made of an elastomeric material, provided between their contiguous edges 13 and 14.

A plurality of arms 15 made of elastomeric material is also provided on the inner surface of both half-shells 10 and 11, protruding from said inner surface.

Diaphragms 17 and 18 respectively, also made of elastomeric material, with a flag-like arrangement, i.e. with one side fixed to said edges 13,16 of the half-shells 10,11 and with the opposite side free (FIG. 4), are also provided on the inner edge 13 of the half-shell 10 and on the outer edge 16 of the half-shell 11 of the gasket 9 of FIG. 4.

In the variant of FIG. 5, the diaphragm 18 of the half-shell 11 is flag-fastened to the inner edge 14 of the same half-shell. The diaphragm 17 is in turn analogously fastened to the inner edge 13 of the half-shell 10.

In the variant of FIG. 6, both diaphragms 17 and 18 are fixed to the respective outer edges 19 and 16 of the corresponding half-shells 10 and 11.

In the installation of the gasket 9 of FIG. 4 on the cable 20 having a small diameter, as represented in FIG. 2, the diaphragms 17 and 18 are closed on the outer surface of the same cable 20. In this arrangement, the diaphragms 17 and 18 compress the cable 20 with the compression force F1 which competes with the same diaphragms as a result of the elastic behaviour of the material forming them. The thrust exerted on the same diaphragms 17 and 18, by the internal arms 15 of the gasket 9, also contributes, according to the invention, to the same compression force F1.

When, on the other hand, a cable 21 having a larger diameter with respect to the cable 20 of FIG. 2 is assembled inside the gasket 9 of FIG. 3, the deformation of the arms is more marked and complete, with the result that these exert a compression force F2 which is much greater than F1 on the diaphragms 17, 18 and therefore also on the cable 21.

Consequently, whereas, on the one hand, with an increase in the diameter of the cables 20 and 21, there is a corresponding increase in their contact surface with the diaphragms 17 and 18, which however does not significantly affect the desired increase in the axial sealing stress of the gasket 9 on the cable 21 having a larger diameter, on the other, the arms 15, due to their greater flexion represented in FIG. 3, generate a compression force F2 proportional to the increase in diameter of the cable. This increased compression force in turn results in an axial retention stress of the cable having a larger diameter, which is equally higher and therefore more suitable for fixing it to said gasket.

For its final assembly, the gasket of the invention is closed with the two half-shells around the cable and tightened inside a cable clamp. The example of FIG. 7 therefore illustrates a cable clamp 22 containing two saddles 23 and 24 for fastening two cables by means of the gaskets described above.

In the assembly solution illustrated in FIG. 8, on the other hand, use is made of a metallic collar 25 with deformable arms 26.

Modifications can be made to the invention, as described above and illustrated in the figures, which however fall within the scope of the following claims.

The arms 15, for example, can have a different arrangement from that illustrated, positioned with any orientation, provided it is suitable for pushing the diaphragms 17 and 18 against the outer surface of the cable, with a force which increases with an increase in the diameter of the latter. The same arms 15 can also be positioned in any points of the inner surface of the half-shells 10 and 11, exerting however the same function described above.

Furthermore, the elongated bodies considered in the invention can consist of elements different from the cables described herein, even if they have the same conformation.

The invention claimed is:

1. A gasket for fastening cables, tubes and other elongated bodies having different diameters, comprising:
two half-shells (10,11) joined together along a hinge (12) at their contiguous edges (13) and (14);
diaphragms (17,18) said half-shells (10,11); and
elastic arms (15) protruding inside said gasket (9) and fastened to inner surfaces of said half-shells (10,11),
wherein said arms (15) are arranged on said half-shells (10,11) to have a free end pushing against a surface of said diaphragms (17,18) when said half-shells are closed around an elongated body.

2. The gasket according to claim 1, wherein each of said diaphragms (17,18) are on extend from one of the inner edges (13,14,16,19) of said half-shells (10,11).

3. The gasket according to claim 2, wherein a first diaphragm (17) is secured at an inner edge (13) of a first half-shell (10) and a second diaphragm (18) is secured at an outer edge (16) of a second half-shell (11).

4. The gasket according to claim 2, wherein a first diaphragm (17) is secured at an inner edge (13) of a first half-shell (10) and a second diaphragm (18) is secured at an inner edge (14) of a second half-shell (11).

5. The gasket according to claim 2, wherein a first diaphragm (17) is secured at an outer edge (19) of a first half-shell (10) and a second diaphragm (18) is secured at an outer edge (16) of a second half-shell (11).

6. The gasket according to claim 1, wherein the gasket is made of elastomeric material.

7. A cable-clamping device for fastening elongated bodies, comprising:
saddles (23,24) provided with a gasket comprising:
two half-shells (10,11) joined together along a hinge (12) at their contiguous edges (13) and (14);
diaphragms (17,18) inside said half-shells (10,11); and
elastic arms (15) protruding inside said gasket (9) and fastened to inner surfaces of said half-shells (10,11),
wherein said arms (15) are arranged on said half-shells (10,11) to have a free end pushing against a surface of said diaphragms (17,18) when said half-shells are closed around an elongated body.

8. A cable-clamping device for fastening elongated bodies, comprising:
a metallic collar (25) having deformable arms (26);
a gasket comprising:
two half-shells (10,11) joined together along a hinge (12) at their contiguous edges (13) and (14);
diaphragms (17,18) inside said half-shells (10,11);
elastic arms (15) protruding inside said gasket (9) and fastened to inner surfaces of said half-shells (10,11),
wherein said arms (15) are arranged on said half-shells (10,11) to have a free end pushing against a surface of said diaphragms (17,18) when said half-shells are closed around an elongated body.
